(19) United States
(12) Patent Application Publication
(10) Pub. No.: US 2013/0011810 A1
(43) Pub. Date: Jan. 10, 2013

(54) BURR FOR ALVEOLAR BONE

(76) Inventor: Sang Choon Cho, New York, NY (US)

(21) Appl. No.: 13/619,320

(22) Filed: Sep. 14, 2012

Related U.S. Application Data
(63) Continuation of application No. PCT/KR2010/006332, filed on Sep. 16, 2010.

(30) Foreign Application Priority Data
Mar. 17, 2010 (KR) 10-2010-0023829

(51) Int. Cl. A61C 3/02

(52) U.S. Cl. 433/165

(57) ABSTRACT

Cutting edges are formed in a main body of a burr, and a connection member that is clamped and fixed in a dental handpiece is connected to the main body. The connection member has an extended portion that extends in a longitudinal direction of the main body, and has a coupling groove formed in the extended portion. The main body includes: a front end portion that has a hemispherical shape, a rear end portion that is directly connected to the connection member, and a curved portion that is disposed between the front end portion and the rear end portion. The curved portion has a diameter which is the smallest at a central portion and increases toward the front end portion and the rear end portion. The cutting edges formed in the main body include longitudinal cutting edges that are formed in the longitudinal direction of the main body.

### CROSS-REFERENCE TO RELATED APPLICATIONS

The present application is a continuation of pending International patent application PCT/KR2010/006332 filed on Sep. 16, 2010 which designates the United States and claims priority from Korean patent application 10-2010-0023829 filed on Mar. 17, 2010, the content of which is incorporated herein by reference.

### FIELD OF THE INVENTION

The present invention relates to a burr for an alveolar bone, and more particularly to, a burr for an alveolar bone which is used to finish an alveolar bone after tooth extraction such that the alveolar bone has an outer shape suitable for placing an implant.

### BACKGROUND OF THE INVENTION

A conventional dental implant procedure involves allowing 6 months after tooth extraction for sufficiently healing an extraction socket, placing an implant, allowing 4 to 6 months to pass, and making an upper prosthesis. Clinical dentists have made efforts to perform an implant procedure at a higher speed, reduce the number of treatments, and reduce a healing time.

One of these recent attempts is to perform an immediate loading procedure which makes an upper prosthesis on the same day an implant is placed. Accordingly, the immediate loading procedure may restore functionality and aesthetic appearance immediately after operation. There are reports that an implant has been successfully placed in an extraction socket immediately after a tooth is extracted. An immediate loading procedure shows a high success rate especially when it is used in a lower jaw where bone tissue is good, and also shows a high success rate when it is used in the whole mouth. An immediate loading procedure is preferred because in an anterior portion of a lower jaw, which has a dental root having a relatively small size, when an alveolar bone is horizontally removed and an implant is placed immediately after tooth extraction, the implant may have as much stability as that when it is placed in a completely healed alveolar bone. In order to perform an immediate loading procedure, an extraction socket, which becomes irregular after tooth extraction, needs to be finished so as to obtain an outer shape of an alveolar bone suitable for placing an implant without damaging an adjacent soft tissue. However, since there is no tool to finish an outer shape of an alveolar bone without damaging an adjacent soft tissue, a burr used to cut a tooth has been used. Accordingly, there is a demand for a burr for an alveolar bone which may be used to finish an outer shape of the alveolar bone.

### SUMMARY OF THE INVENTION

The present invention provides a burr for an alveolar bone which may be used for an existing handpiece and suitable for finishing an outer shape of the alveolar bone.

According to an aspect of the present invention, there is provided a burr for an alveolar bone, the burr including: a main body in which cutting edges are formed; and a connection member that is clamped and fixed in a dental handpiece, is connected to the main body, extends in a longitudinal direction of the main body to have an extended portion, and has a coupling groove formed in the extended portion thereof, wherein the main body includes: a front end portion that has a hemispherical shape; a rear end portion that is directly connected to the connection member; and a curved portion that is disposed between the front end portion and the rear end portion, and has a diameter which is the smallest at a central portion and increases toward the front end portion and the rear end portion, wherein the cutting edges formed in the main body include longitudinal cutting edges that are formed in the longitudinal direction of the main body.

Circumferential grooves may be formed in a circumferential direction of the main body perpendicular to the longitudinal direction of the main body.

A spiral groove may be spirally formed in a circumferential direction of the main body.

The cutting edges formed in the main body may have heights which are great at the curved portion having the smallest diameter and increase toward the front end portion and the rear end portion.

A burr for an alveolar bone according to the present invention may be used by being attached to an existing handpiece for an implant procedure and may be repeatedly used through sterilization. Also, since the burr formed of stainless steel is used after processing and heat treatment, the burr does not leave a residue when an alveolar bone is finished, unlike a diamond burr. In particular, since the burr according to the present invention enables an alveolar bone after tooth extraction to easily have a shape similar to a shape of a healed alveolar bone, an implant procedure may be easily completed on the same day as a tooth is extracted.

Also, in an implant procedure performed on an upper jaw, the burr according to the present invention may be effectively used to raise a mucous membrane of a maxillary sinus during a maxillary sinus augmentation procedure, graft a bone in a space formed by raising the mucous membrane, and secure the bone in place. If the burr according to the present invention is used when the maxillary sinus is opened for the maxillary sinus augmentation procedure, an area of a window may be increased without cutting the mucous membrane of the maxillary sinus.

### BRIEF DESCRIPTION OF THE DRAWINGS

FIG. 1 is a perspective view illustrating a burr for an alveolar bone, according to an embodiment of the present invention.

FIG. 2 is a bottom view illustrating the burr of FIG. 1.

FIG. 3 is a side view illustrating a burr for an alveolar bone, according to another embodiment of the present invention.

FIG. 4 is a photograph illustrating an alveolar bone exposed when a tooth is extracted and a gum is cut.

FIG. 5 is a photograph illustrating the alveolar bone finished by using a burr for an alveolar bone according to the present invention.

FIG. 6 is a photograph illustrating the alveolar bone in which a hole is formed to place a screw for an implant.

FIG. 7 is a photograph illustrating the alveolar bone in which the screw for the implant is placed.

FIG. 8 is a photograph illustrating that a burr is inserted through an open window when a maxillary sinus is opened for a maxillary sinus augmentation procedure.

### EXPLANATION OF REFERENCE NUMERALS DESIGNATING THE MAJOR ELEMENTS OF THE DRAWINGS

100, 200: burr for alveolar bone

110, 210: main body

110a, 210a: curved portion

110b, 210b: front end portion

110c, 210c: rear end portion

111: cutting edges

112: circumferential grooves

150: connection member

212: spiral groove

### DETAILED DESCRIPTION OF THE INVENTION

The term “burr” used herein refers to a dental tool which is clamped in a handpiece. The “burr” is widely used in the field of dentistry.

The present invention will now be described more fully with reference to the accompanying drawings, in which exemplary embodiments of the invention are shown.

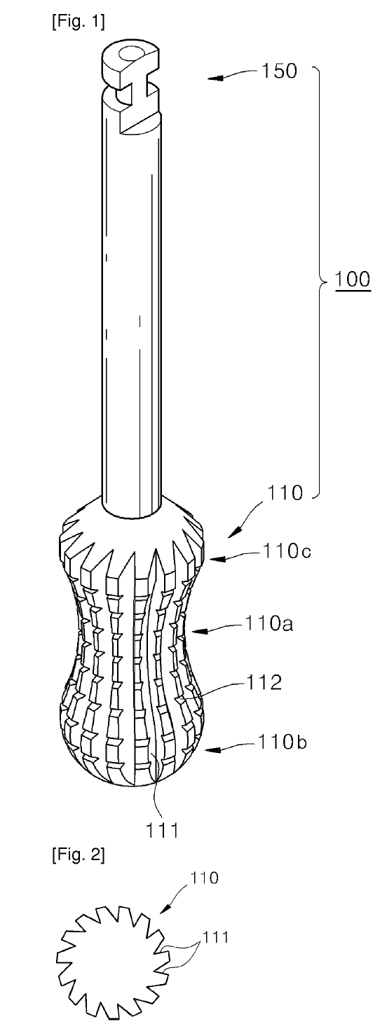

FIG. 1 is a perspective view illustrating a burr 100 for an alveolar bone, according to an embodiment of the present invention. FIG. 2 is a bottom view illustrating the burr 100 of FIG. 1.

Referring to FIGS. 1 and 2, the burr 100 includes a main body 110 and a connection member 150.

The main body 110 having cutting edges 111 and used to finish an alveolar bone while rotating has a substantially dumbbell shape and includes a curved portion 110a, a front end portion 110b, and a rear end portion 110c.

The curved portion 110a has the cutting edges 111 and has a diameter which is the smallest at a central portion and increases toward both the front end portion 110b and the rear end portion 110c to conform to a shape of the alveolar bone.

The front end portion 110b has a substantially hemispherical outer shape such that a portion pressed when a force is applied in a longitudinal direction is not damaged. The use of the front portion 110b will be explained below.

The rear end portion 110c which is connected to the connection member 150 has substantially the same outer diameter as an outer diameter of the front end portion 110b.

The main body 110 including the front end portion 110b, the curved portion 110a, and the rear end portion 110c may be formed to have a dumbbell shape as a whole. Also, the plurality of cutting edges 111, each of which is linear, are arranged in the longitudinal direction over the front end portion 110b, the curved portion 110a, and the rear end portion 110c. Since the cutting edges 111 are arranged in the longitudinal direction, the main body 110 has a sawtooth shape when it is viewed from the bottom.

Since the main body 110 has a substantially dumbbell shape, heights of the cutting edges 111 formed in the curved portion 110a having the smallest diameter are less than those of the cutting edges 111 formed in the front end portion 110b and the rear end portion 110c. In particular, when the cutting edges 111 of the main body 110 are formed to have heights which are great at the curved portion 110a having the smallest diameter and increase toward the front end portion 110b and the rear end portion 110c, a central portion of the alveolar bone may be precisely cut little by little and the main body 110 may be conveniently made and processed.

In addition to the cutting edges 111 which are formed in the longitudinal direction, circumferential grooves 112 are formed in a circumferential direction of the main body 110. The circumferential grooves 112 of FIG. 1 are formed at predetermined intervals in a direction perpendicular to the longitudinal direction.

Since a process of finishing the alveolar bone is not performed on an object having a uniform shape and once the alveolar bone is cut, the alveolar bone may not return to its original shape, it is preferable that the alveolar bone is cut little by little by forming the circumferential grooves 112 in the circumferential direction.

The connection member 150 has a standardized shape such that the burr 100 is clamped in an existing handpiece. That is, a stepped portion is formed in the longitudinal direction at an end portion of the connection member 150, and a coupling groove is formed at a predetermined distance from an end of the connection member 150. Here, the term “handpiece” refers to a member which, when any of various types of burrs is clamped in the handpiece, rotates the burr and provides a rotational force for cutting a tooth, and is widely used in the field of dentistry.

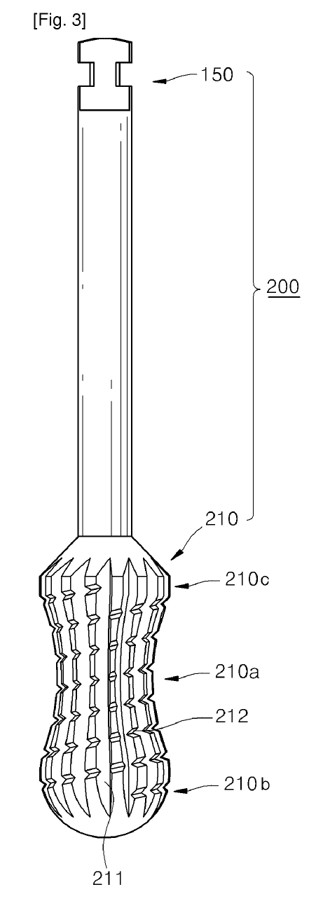

FIG. 3 is a side view illustrating a burr 200 for an alveolar bone, according to another embodiment of the present invention.

Referring to FIG. 3, the burr 200 of FIG. 3 is different from the burr 100 of FIG. 1 in that a circumferential groove 212 of a main body 210 is spirally formed in a longitudinal direction of the main body 210. That is, while the circumferential grooves 112 of FIG. 1 are formed in the circumferential direction of the main body 110 to be parallel to one another, one spiral groove 212 of FIG. 3 is spirally formed in the longitudinal direction of the main body 210. The main body 210, a curved portion 210a, a front end portion 210b, a rear end portion 210c, cutting edges 211, and the connection member 150 are substantially the same as the main body 110, the curved portion 210a, the front end portion 110b, the rear end portion 110c, the cutting edges 111, and the connection member 150 of FIG. 1, respectively.

In practice, any of the burrs 100 and 200 of FIGS. 1 and 3 may be effectively used to finish a shape of the alveolar bone.

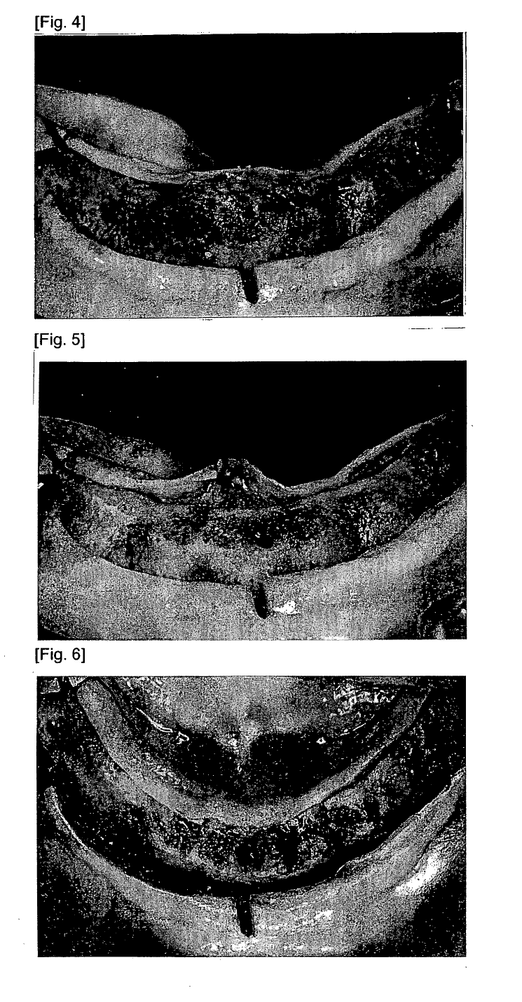

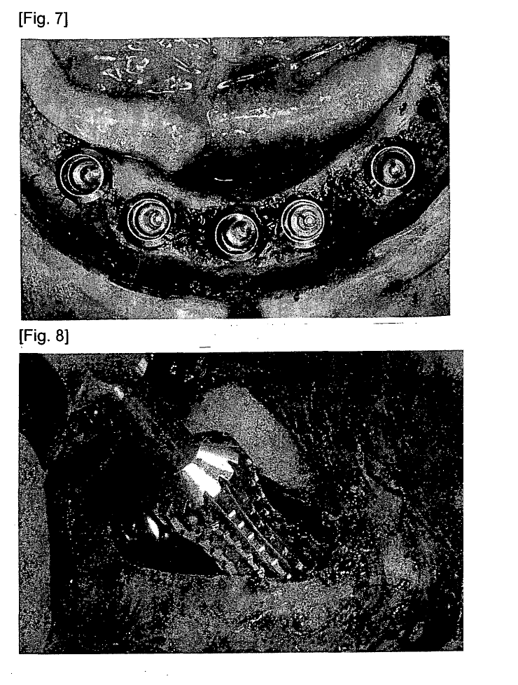

FIGS. 4 through 7 are photographs sequentially illustrating a procedure of finishing an alveolar bone by using a burr for an alveolar bone according to the present invention and placing a screw for an implant in the alveolar bone. That is, FIG. 4 is a photograph illustrating the alveolar bone exposed after a tooth is extracted and a gum is cut. FIG. 5 is a photograph illustrating the alveolar bone finished by using the burr according to the present invention. FIG. 6 is a photograph illustrating the alveolar bone in which a hole is formed to place the screw for the implant. FIG. 7 is a photograph illustrating the alveolar bone in which the screw for the implant is placed. As shown in FIGS. 4 through 7, the burr according to the present invention is very useful to finish an alveolar bone such that the alveolar bone has an outer shape suitable for placing an implant.

In order to use the burr according to the present invention for one patient and then for another patient, the burr has to be sterilized. The burr may be sterilized by using an autoclave.

A distance between a portion of a front end portion having a greatest diameter and a portion of a rear end portion having a greatest diameter in the burr according to the present invention is determined by a width of a person's alveolar bone. Since a width of an alveolar bone varies according to people, a set of burrs may be made such that distances between front end portions and rear end portions are different and may be used such that a burr having a distance corresponding to a width of an alveolar bone of a patient is selected.

The burr according to the present invention may be effectively used when a maxillary sinus augmentation procedure is performed. A maxillary sinus augmentation procedure, which involves raising the mucous membrane of the maxillary sinus for an implant procedure, grafting a bone, and artificially forming an alveolar bone thick enough to place an implant, is a well-known procedure in the field of dentistry. In order to perform the maxillary sinus augmentation procedure, a tool having a relatively small diameter and a round shape needs to be used to raise the mucous membrane of the maxillary sinus, graft the bone, and secure the bone in place. Since the burr according to the present invention has a main body having a hemispherical front end portion, the burr may be effectively used to raise the mucous membrane of the maxillary sinus, graft the bone, and secure the bone in place.

When the maxillary sinus augmentation procedure is performed, a window which communicates with the maxillary sinus is formed by forming a hole in the alveolar bone, and the bone to be grafted and a tool for finishing the bone are inserted through the window. FIG. 8 is a photograph illustrating that the burr is inserted through a window when the maxillary sinus is opened for the maxillary sinus augmentation procedure.

If an existing burr is used in order to increase an area of the window when the maxillary sinus is opened for the maxillary sinus augmentation procedure, a front end portion of the existing burr is so sharp that the mucous membrane of the maxillary sinus tends to be cut. However, when the burr according to the present invention is used, since the front end portion has a hemispherical shape and does not damage the mucous membrane even when the burr rotates, the burr according to the present invention may be effectively used to increase an area of the window.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A burr for an alveolar bone, the burr comprising:
a main body in which cutting edges are formed; and
a connection member that is clamped and fixed in a dental handpiece, is connected to the main body, extends in a longitudinal direction of the main body to have an extended portion, and has a coupling groove formed in the extended portion thereof,
wherein the main body comprises:
a front end portion that has a hemispherical shape;
a rear end portion that is directly connected to the connection member; and
a curved portion that is disposed between the front end portion and the rear end portion, and has a diameter which is the smallest at a central portion and increases toward the front end portion and the rear end portion,
wherein the cutting edges formed in the main body comprise longitudinal cutting edges that are formed in the longitudinal direction of the main body.

2. The burr of claim 1, wherein circumferential grooves are formed in a circumferential direction of the main body perpendicular to the longitudinal direction of the main body.

3. The burr of claim 1, wherein a spiral groove is spirally formed in a circumferential direction of the main body.

4. The burr of claim 1, wherein the cutting edges formed in the main body have heights which are great at the curved portion having the smallest diameter and increase toward the front end portion and the rear end portion.
